(19) United States
(12) Patent Application Publication
(10) Pub. No.: US 2024/0385614 A1
(43) Pub. Date: Nov. 21, 2024

(54) BUILDING MANAGEMENT SYSTEM WITH RESOURCE IDENTIFICATION AND ENHANCEMENT

(71) Applicant: Tyco Fire & Security GmbH, Neuhausen am Rheinfall (CH)

(72) Inventors: Joseph Morris, Milwaukee, WI (US); Matthew P. Kaiser, Milwaukee, WI (US); Gene P. David, Milwaukee, WI (US); Stephen P. Landon, Milwaukee, WI (US); Carol T. Tumey, Wauwatosa, WI (US)

(21) Appl. No.: 18/664,194

(22) Filed: May 14, 2024

Related U.S. Application Data
(60) Provisional application No. 63/466,602, filed on May 15, 2023.

(51) Int. Cl. G05B 23/02; G05B 15/02

(52) U.S. Cl. CPC G05B 23/0294; G05B 15/02

(57) ABSTRACT

A method includes performing, by one or more processors, a scan of a building management system to determine an indication of available resources of the building management system, determining, by the one or more processors, by processing the indication of the available resources of the building management system using at least one generative artificial intelligence (AI) model, a difference between the available resources of the building management system and a requirements of a feature for the building management system, and performing, by the one or more processors, one or more actions according to the difference.

### CROSS-REFERENCE TO RELATED APPLICATION

This application claims priority to and the benefit of U.S. Provisional Application No. 63/466,602, filed May 15, 2023, the entire disclosure of which is incorporated by reference herein.

### BACKGROUND

This application relates generally to a building system of a building. This application relates more particularly to systems for managing and processing data of the building system.

Various interactions between building systems, components of building systems, users, technicians, and/or devices managed by users or technicians can rely on timely generation and presentation of data relating to the interactions, including for planning or performing service operations, for example for installation of new components to enable additional or improved features of a building management system. However, it can be difficult to generate the data elements to precisely identify proper response actions or sequences of response actions, as well as options for modified response actions, depending on various factors associated with items of equipment to be serviced, technical issues with the items of equipment, and the availability of timely, precise data to use for supporting the service operations. For instance, it can be difficult to ascertain the equipment, devices, and other resources already available in a building management system and associated service, installation, upgrade, or other tasks that would be advantageous to a particular building management system.

### SUMMARY

One implementation of the present disclosure is a method. The method includes performing, by one or more processors, a scan of a building management system to determine an indication of available resources of the building management system, determining, by the one or more processors, by processing the indication of the available resources of the building management system using at least one generative artificial intelligence (AI) model, a difference between the available resources of the building management system and a requirements of a feature for the building management system, and performing, by the one or more processors, one or more actions according to the difference.

In some embodiments, the one or more actions include providing, by the one or more processors, a signal to modify the available resources according to the difference. The one or more actions can include generating, using the at least one generative AI model, a proposed update for eliminating the difference and enabling the feature for the building management system; generating, using the at least one generative AI model, a customized script for presenting the proposed update to a building manager; generating, using the at least one generative AI model, a quote for implementing the proposed update; and/or generating, using the at least one generative AI model, a scope of work, purchase order, or bill of materials for implementing the proposed update. In some embodiments the proposed update includes installing a new device or equipment unit in the building management system and the one or more actions can include generating configuration parameters or settings for the new device or equipment unit.

In some embodiments, the one or more actions include generating, by the at least one AI model using the indication, a video including a demonstration of a maintenance action for reducing or eliminating the difference. The one or more actions can include transmitting, by the one or more processors to a device of a user associated with the one or more items of equipment, an instruction to retrieve information regarding the available resources. Retrieving the information can include manually checking equipment or device status, collecting state data, capturing a photograph or video, and/or providing natural language input regarding observations by the user.

The at least one generative AI model can include at least one neural network comprising a transformer. Determining the difference can include cross-site comparison between the available resources of the building management system and a plurality of additional building management systems, where the feature is present in at least one of the plurality of additional building management systems. The at least one generative AI model can be configured using training data comprising sets of resources and enabled features of a plurality of additional building management systems. The at least one generative AI model can be configured using training data comprising project documentation comprising one or more of quotes, estimates, scopes of work, bills of materials, installation records, or invoices. The difference can include a lack of a sensor, a lack of sufficient computing resource availability, or a lack of a type of equipment in the building management system.

Another implementation of the present disclosure is a processing system programmed to perform a scan of the building management system to determine an indication of available resources of the building management system, determine by processing the indication of the available resources of the building management system using at least one generative artificial intelligence (AI) model, a difference between the available resources of the building management system and a requirements of a feature for the building management system, and perform one or more actions according to the difference. The processing system can be programmed according to execute the various methods described herein.

Another implementation of the present disclosure is a method for training a generative artificial intelligence (AI) network. The method includes providing results of a plurality of scans of a plurality of building management systems configured to determine available resources of the plurality of building management systems, providing performance data relating to the plurality of building management systems, and adapting the generative AI network using the results and the performance data such that the generative AI network is configured to generate content describing an action to perform to update a particular building management system to achieve a performance enhancement for the particular building management system. The performance data can include indications of smart building features enabled at the plurality of building management systems.

The method can also include providing project documentation comprising one or more of quotes, estimates, scopes of work, bills of materials, installation records, or invoices and adapting the generative AI network using the project documentation such the generative AI network is configured to generate proposed project documentation regarding implementing the update.

Another implementation of the present disclosure is a method that can include performing, by one or more processors, a scan of a building management system to determine an indication of available resources of the building management system, and automatically generating, by the one or more processors, by processing the indication of the available resources of the building management system, a proposal for resolving a difference between the available resources of the building management system and a requirement of a feature for the building management system. The method can also include performing, by the one or more processors, one or more actions according to the proposal. The feature for the building management system may be expected to improve performance of the building management system, and generating the proposal can be based on data from a plurality of additional scans of a plurality of additional building management systems and performance data for the plurality of additional building management systems.

Another implementation of the present disclosure is a method. The method includes running a scan of a building management system, the scan configured to identify equipment and devices of the building management system. the points of the building management system can be initially undefined. The method further includes defining a first portion of points based on the scan and a common data model, generating proposed definitions for a second portion of the points using at least one generative AI model, confirming the proposed definitions based on expert supervision, and executing a smart building feature using the first portion of the points and the second portion of the points.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for equipment servicing applications.

FIG. 2 is a block diagram of an example of a language model-based system for equipment servicing applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of managing equipment servicing responsive to fault detection using machine learning models.

FIG. 9 is a block diagram illustrating a performance assessment tool.

FIG. 10 is a flow diagram illustrating a process for implementing updates to a BMS to enable one or more smart building features.

FIG. 11 is a flow diagram illustrating a process for implementing smart building features in response to changes to a BMS.

FIG. 12 is a flow diagram of a process for implementing smart building features using initially undefined points of a BMS.

FIG. 13 is an illustration of computing architecture that may be used to implement features herein.

FIG. 14 is a screen shot illustrating an example smart building site assessment report.

FIG. 15 is a flow diagram of a process for implementing smart building features, according to some embodiments.

### DETAILED DESCRIPTION

Referring generally to the FIGURES, systems and methods in accordance with the present disclosure can implement various systems to precisely generate data relating to operations to be performed for managing building systems and components and/or items of equipment, including heating, ventilation, cooling, and/or refrigeration (HVAC-R) systems and components. For example, various systems described herein can be implemented to more precisely generate data for various applications including, for example and without limitation, virtual assistance for supporting technicians responding to service requests; generating technical reports corresponding to service requests; facilitating diagnostics and troubleshooting procedures; recommendations of services to be performed; and/or recommendations for products or tools to use or install as part of service operations, for example additions which can enable new features such as smart building features. Various such applications can facilitate both asynchronous and real-time service operations, including by generating text data for such applications based on data from disparate data sources that may not have predefined database associations amongst the data sources, yet may be relevant at specific steps or points in time during service operations.

In some systems, service operations can be supported by text information, such as predefined text documents such as service, diagnostic, and/or troubleshooting guides. Various such text information may not be useful for specific service requests and/or technicians performing the service. For example, the text information may correspond to different items of equipment or versions of items of equipment to be serviced. The text information, being predefined, may not account for specific technical issues that may be present in the items of equipment to be serviced.

In some systems, high variability across facilities (buildings, campuses, etc.) and building management systems can make it difficult for rules-based programing do determine differences between the resources currently available in a building management sources and the set of resources required for execution of additional features such as smart buildings features. The teachings herein enable processing of such data to determine, quote, and/or implement updates to provides a building management system with the resources that enable execution of advantageous additional features via the building management systems to improve system operations.

AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from technician service reports in various formats, including various modalities and/or multi-modal formats (e.g., text, speech, audio, image, and/or video) and/or data relating to resources and features available in various building management systems and/or data relating to performance of different building management systems. The system can facilitate automated, flexible customer report generation, such as by processing information received from service technicians and other users into a standardized format, which can reduce the constraints on how the user submits data while improving resulting reports. The system can couple unstructured service data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend detection operations to facilitate more timely assignment of technicians, scheduling of technicians based on expected times for jobs, and provisioning of trucks, tools, and/or parts. The system can perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for fault detection and servicing processes in which a machine learning model is configured based on connecting or relating unstructured data and/or semantic data, such as human feedback and written/spoken reports, with time-series product data regarding items of equipment, so that the machine learning model can more accurately detect causes of alarms or other events that may trigger service responses. For instance, responsive to an alarm for a chiller, the system can more accurately detect a cause of the alarm, and generate a prescription (e.g., for a service technician) for responding to the alarm; the system can request feedback from the service technician regarding the prescription, such as whether the prescription correctly identified the cause of the alarm and/or actions to perform to respond to the cause, as well as the information that the service technician used to evaluate the correctness or accuracy of the prescription; the system can use this feedback to modify the machine learning models, which can increase the accuracy of the machine learning models.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can enable a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for repairing or inspecting the equipment to identify information that the system can use to detect root causes or other issues. The system can use the interface to present information regarding parts and/or tools to service the equipment, as well as instructions for how to use the parts and/or tools to service the equipment.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

### I. Machine Learning Models for Building Management and Equipment Servicing

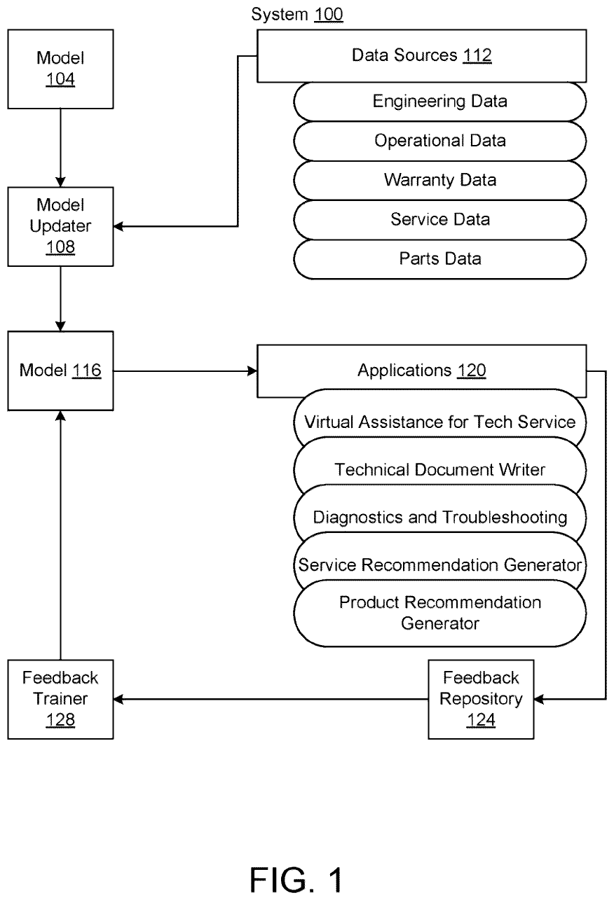

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment servicing operations.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as technical documents (e.g., service guides) that include both text and image/video information.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers). For example, using the first model 104 and/or second model 116 to process the data can allow the system 100 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 100 to predict resources to use for performing service as well as when to request service.

The data sources 112 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 112 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 112 can include parts data, including but not limited to parts usage and sales data. For example, the data sources 112 can indicate various parts associated with installation or repair of items of equipment. The data sources 112 can indicate tools for performing service and/or installing parts.

The system 100 can include, with the data of the data sources 112, labels to facilitate cross-reference between items of data that may relate to common items of equipment, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., engineering data, operational data, and service data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can enable the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof. The applications 120 can include user interfaces, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for users such as service technicians, facility managers, or other occupants, and provide the received responses to at least one of the second model 116 or a root cause detection function (e.g., algorithm, model, data structure mapping inputs to candidate causes, etc.) to determine a prediction of a cause of the issue of the item of equipment and/or solutions. The virtual assistant application 120 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that the problem is with temperature in the space, the system 100 can request, via the virtual assistant application 120, information regarding HVAC-R equipment associated with the space, such as pictures of the space, an air handling unit, a chiller, or various combinations thereof.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a service technician user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 120, etc.), such as to enable the system 100 to update the information generated by the second model 116 for the virtual assistant application 120 according to the engagement. In some implementations, the system 100 can use the second model 116 to detect sentiment of the user of the virtual assistant application 120, and update the second model 116 according to the detected sentiment, such as to improve the experience provided by the virtual assistant application 120.

The applications 120 can include at least one document writer application 120, such as a technical document writer. The document writer application 120 can facilitate preparing structured (e.g. form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

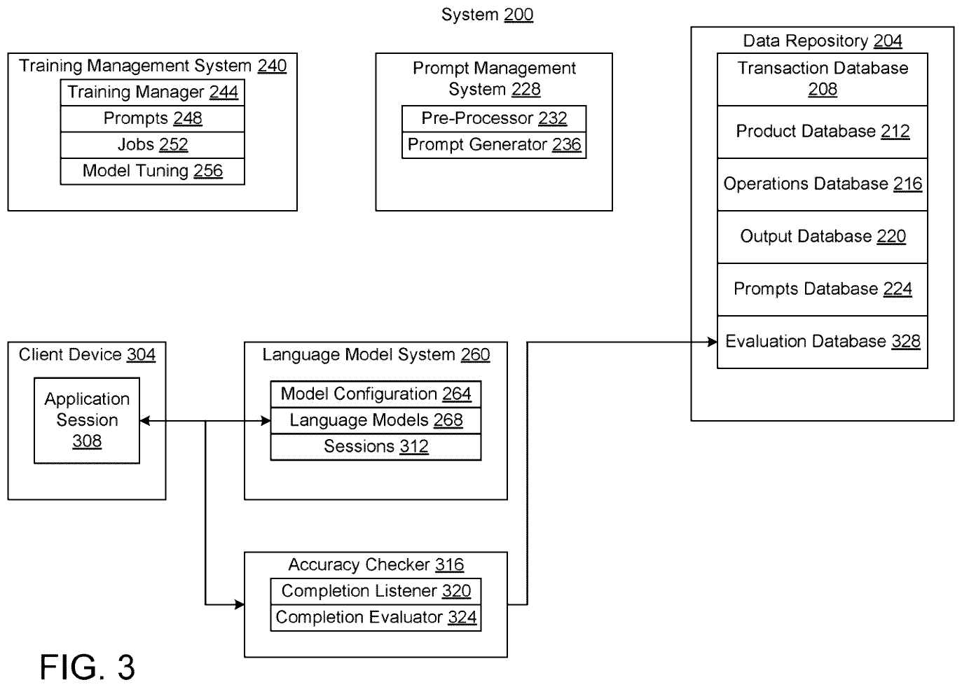

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### II. System Architectures for Generative AI Applications for Building Management System and Equipment Servicing

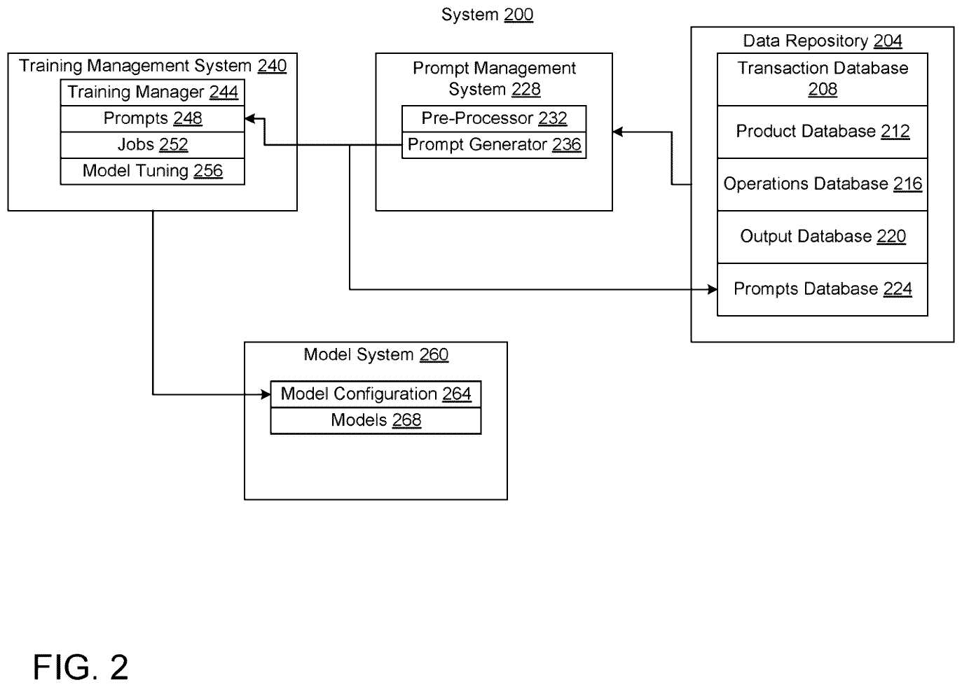

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to enable generative AI applications for building managements systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used for service transactions; sales data indicating various service transactions or other transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 228, and determine training data elements that include examples of input and outputs for generation by machine learning models, such as a training data element that includes a prompt and a completion corresponding to the prompt, based on the data from the data repository 228.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which may include at least one of the first prompt or the first completion concatenated to the second prompt), and provide the second completion to the application session 308.

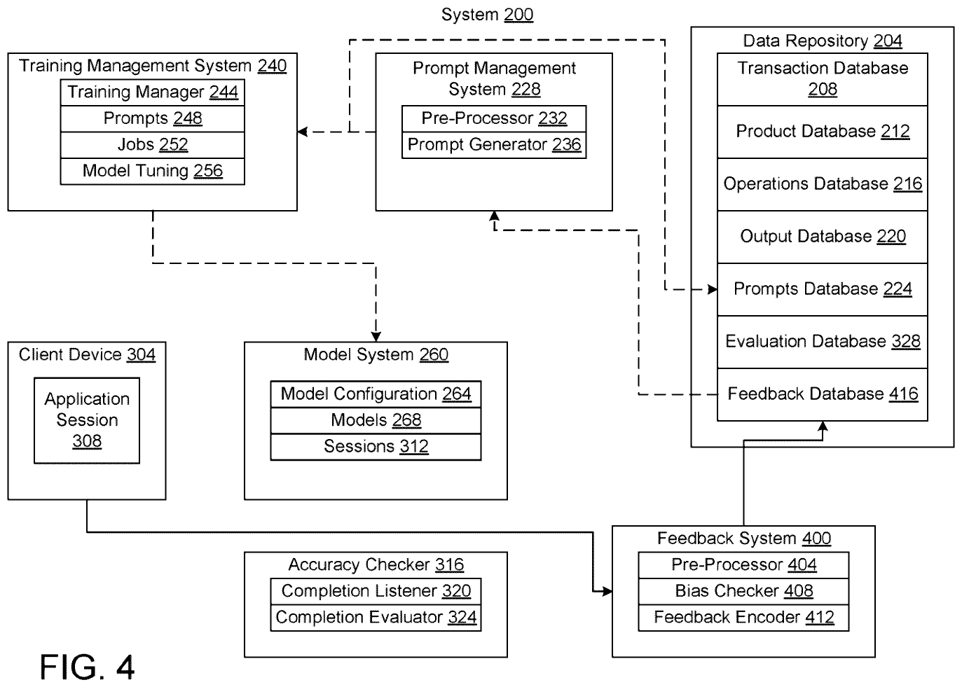

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 320 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 400. The pre-processor 400 can perform any of various operations to modify the feedback for further processing. For example, the pre-processor 400 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

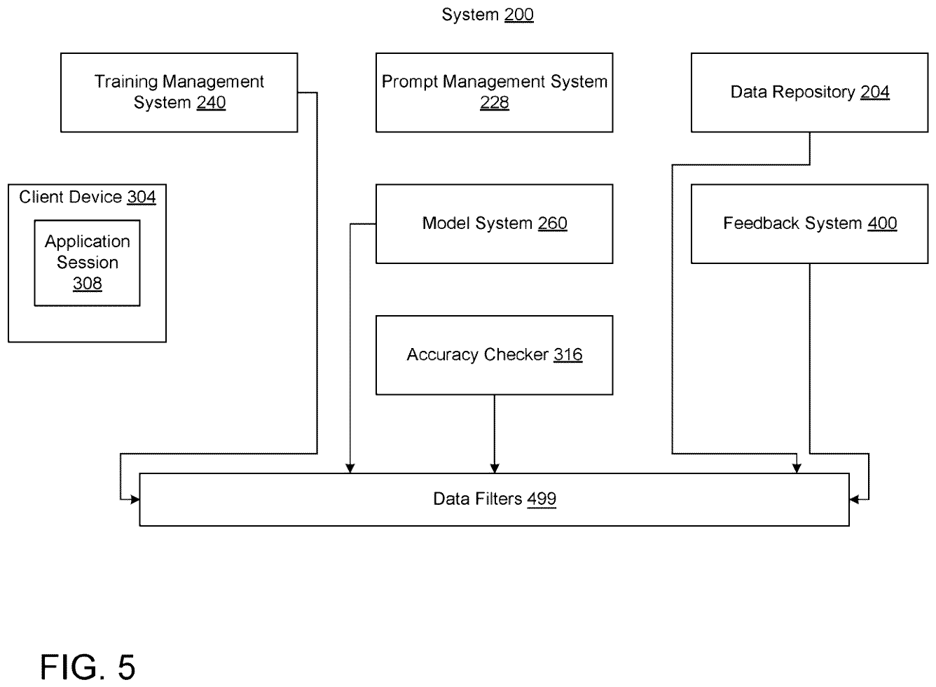

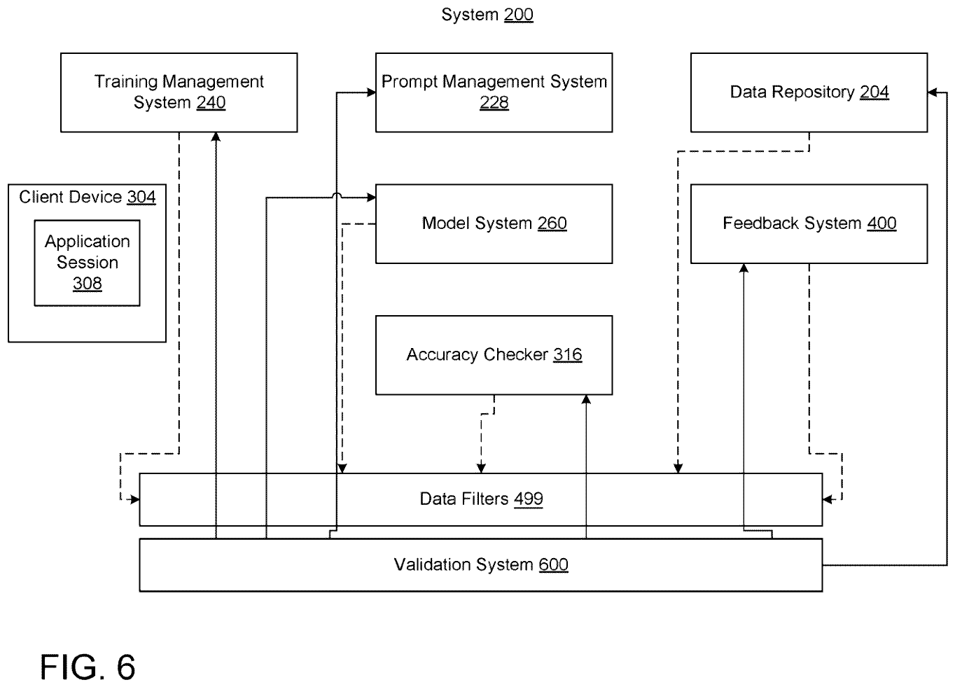

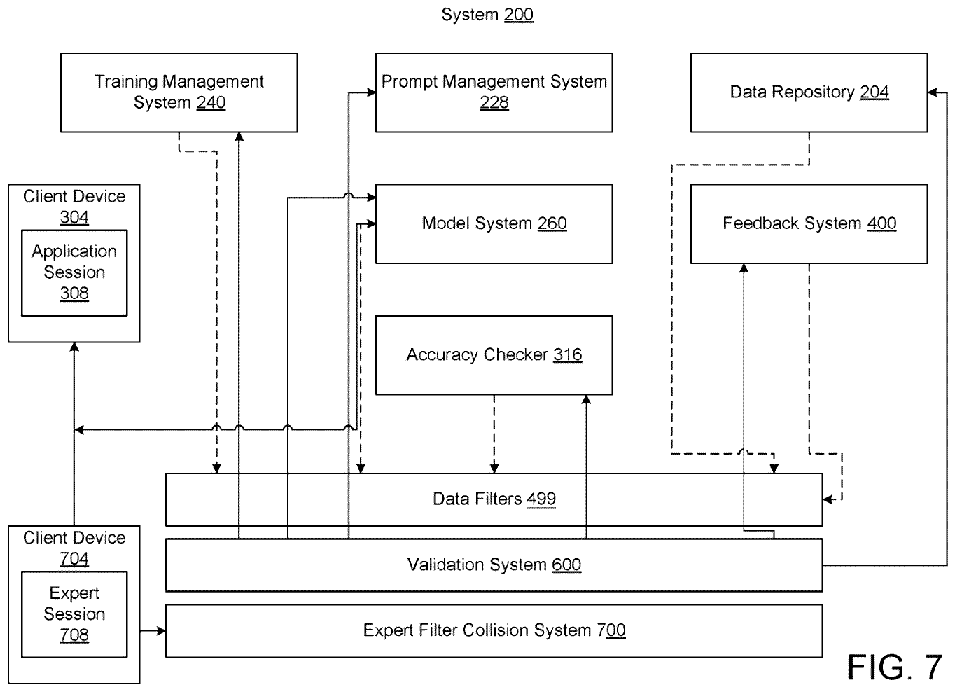

FIG. 5 depicts an example of the system 200, where the system 200 can include one or more data filters 499 (e.g., data validators). The data filters 499 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can enable the system 200 to implement timely operations for improving the precision and/or accuracy of completions or other information generated by the system 200 (e.g., including improving the accuracy of feedback data used for fine-tuning the machine learning models 268). The data filters 499 can allow for interactions between various algorithms, models, and computational processes.

For example, the data filters 499 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 499 can enable the system 200 to detect when data, such as prompts, completions, or other inputs and/or outputs of the system 200, collide with thresholds that represent realistic behavior or operation or other limits of items of equipment. For example, the thresholds of the data filters 499 can correspond to values of data that are within feasible or recommended operating ranges. In some implementations, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 499 can be based on information from various data sources. The thresholds can include, for example and without limitation, thresholds based on information such as equipment limitations, safety margins, physics, expert teaching, etc. For example, the data filters 499 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 499 correspond to a given setup. For example, the setup can represent a configuration of a corresponding item of equipment (e.g., configuration of a chiller, etc.). The data filters 499 can represent various thresholds or conditions with respect to values for the configuration, such as feasible or recommendation operating ranges for the values. In some implementations, one or more data filters 499 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 499 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 499 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 499. In some implementations, the system 200 can pass data to a destination without modifying the data (e.g., retaining a value of the data prior to evaluation by the data filter 499) responsive to the data satisfying the criteria of the respective data filter(s) 499. In some implementations, the system 200 can at least one of (i) modify the data or (ii) output an alert responsive to the data not satisfying the criteria of the respective data filter(s) 499. For example, the system 200 can modify the data by modifying one or more values of the data to be within the criteria of the data filters 499.

In some implementations, the system 200 modifies the data by causing the machine learning models 268 to regenerate the completion corresponding to the data (e.g., for up to a predetermined threshold number of regeneration attempts before triggering the alert). This can enable the data filters 499 and the system 200 selectively trigger alerts responsive to determining that the data (e.g., the collision between the data and the thresholds of the data filters 499) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 499) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 499. This can enable the validation system 600 to trigger validation of the data responsive to collision of the data with the criteria of the data filters 499. For example, responsive to the data filters 499 determining that an item of data does not satisfy a corresponding criteria, the data filters 499 can provide the item of data to the validation system 600. The data filters 499 can assign various labels to the item of data, such as indications of the values of the thresholds that the data filters 499 used to determine that the item of data did not satisfy the thresholds. Responsive to receiving the item of data from the data filters 499, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 499) and can provide the indication to the data filters 499 to cause the data filters 499 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 499 that processes the data. This can enable the system 200, the data filters 499, and the validation system 600 to update the machine learning models 268 and other machine learning aspects (e.g., generative AI aspects) of the system 200 to more accurately generate data and completions (e.g., enabling the data filters 499 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert session 700 can enable functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some implementations, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 708 to selectively identify experts to use for monitoring and validating the data.

In some implementations, the expert system 700 facilitates a communication session regarding the data, between the application session 308 and the expert session 708. For example, the expert session 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some implementations, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to enable the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian patent application No. 202341008712, filed Feb. 10, 2023, the disclosures of which are incorporated herein by reference in their entireties.

### III. Generative AI-Based Systems and Methods for Equipment Servicing

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Equipment Service Management Responsive to Fault Detection Using Machine Learning Models

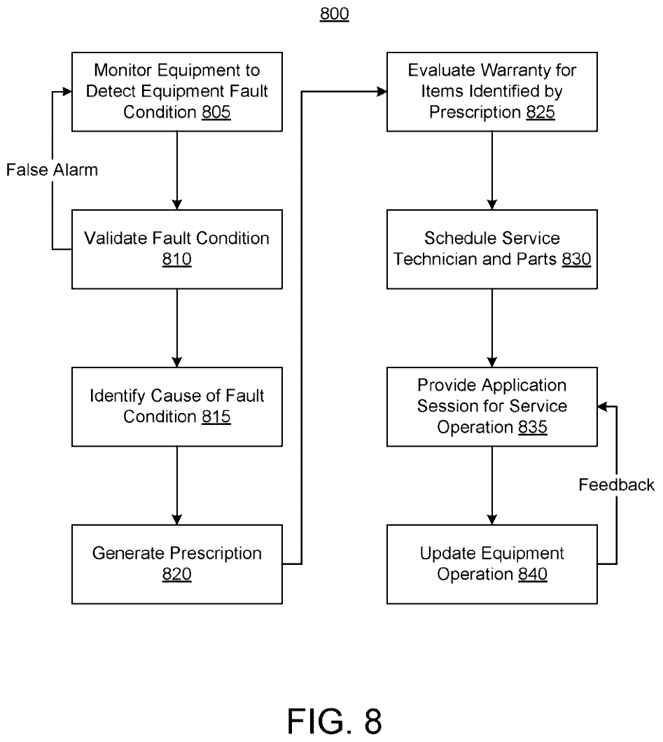

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures.

At 805, a fault condition of an item of equipment can be detected. The fault condition can be detected responsive to manual and/or automated monitoring of various data sources regarding the item of equipment. In some implementations, the fault condition is detected responsive to an alarm notification from an alarm of the equipment or coupled with the equipment. For example, sensor data of the equipment or from a sensor directed to the equipment can be monitored by the alarm, and evaluated according to one or more alarm conditions (e.g., threshold values) to trigger the alarm notification. The fault condition can be detected responsive to user input indicative of the fault condition, or images or other data received indicative of the fault condition.

At 810, the fault condition can be validated. For example, the fault condition can be validated to determine whether the alarm notification corresponds to a false alarm. In some implementations, the fault condition can be validated by verifying the data used to detect the fault condition at a second point in time (e.g., subsequent to a first point in time at which the fault condition was initially detected), such as by evaluating the one or more alarm conditions using data regarding the equipment at the second point in time; this may include using the same or different data than the data used to initially detect the fault condition to validate the fault condition. The fault condition can be validated by providing the alarm notification to a device of a user, and requesting a confirmation (or indication of false alarm) from the user via the device. Responsive to the fault condition being identified as a false alarm, the equipment can be continued to be monitored.

At 815, a cause of the fault condition can be identified, such as by performing a root cause analysis. In some implementations, the cause is detected using a function that includes one or more algorithms, tables, simulations, or machine learning models described herein. For example, at least one of an identifier of the equipment, the fault condition, user text or speech identifying the fault condition (e.g., notes from any of a variety of entities, such as a facility manager, on-site technician, etc.), or data regarding the equipment used to detect the fault condition can be applied as input to the function to enable the function to determine an indication of a cause of the fault condition. For example, the function can include a table mapping various such inputs to one or more causes of fault conditions. The function can include a machine learning model configured using various forms of data described herein. For example, the machine learning model can include one or more classifiers, language models, or combinations thereof that are trained using data that includes information indicative of fault conditions and associated causes of fault conditions.

At 820, a prescription is generated based on the cause of the fault condition. For example, one or more of the cause of the fault condition, the fault condition, and an identifier of the equipment can be provided to a language model to cause the language model to generate the prescription. The prescription can have a natural language format. The prescription can indicate one or more actions for a service technician to perform to verify, service, and/or repair the fault condition, such as instructions for tools and/or parts to use for the item of equipment. The language model can include any of various models described herein that are configured, using training data representative of prescriptions. The prescription can be generated for presentation using various output modalities, such as text, speech, audio, image, and/or video, including in real-time, conversational, or asynchronous formats.

In some implementations, generating the prescription includes conditioning or guiding the language model to generate the prescription based on a class of at least one of the service technician or the site at which the item of equipment is present. For example, the language model can have its configuration (e.g., training, etc.) modified according to labels of identifiers or classes of technicians, sites, types of equipment, or other characteristics relating to the item of equipment and/or the service technician, which can enable the prescription to be generated in a manner that is more accurate and/or relevant to the service to be performed.

At 825, a warranty is evaluated based on one or more items (e.g., the equipment, parts or tools for servicing the equipment) identified by the prescription. For example, the warranty can be retrieved from various sources, such as a contract database associated with the entity that maintains the site, according to an identifier of the type of equipment, from the service request, or various combinations thereof. The prescription (or the service request) can be parsed to identify one or more items, such as items of equipment, identified by the prescription. For example, the item of equipment for which the service request is generated can be identified from the prescription, and compared with the warranty (e.g., using natural language processing algorithms, etc.) to identify one or more warranty conditions assigned to the item of equipment. The warranty conditions can indicate, for example, timing criteria for authorizing and/or payment for servicing the item of equipment by a vendor or supplier of the item of equipment. Responsive to the warranty conditions being satisfied (e.g., a termination of the warranty not being met), various actions can be performed to trigger servicing of the item of equipment. In some implementations, one or more warranty conditions are evaluated prior to, during, and or subsequent to generation of the prescription, such as to allow the prescription to be generated to incorporate one or more outputs of the evaluation of the warranty (or avoid computational resources for generating the prescription responsive to the warranty conditions not being satisfied).

At 830, scheduling of deployment of at least one of a service technician or one or more parts identified by the prescription can be performed. In some implementations, the prescription can identify the service technician, such as to select the service technician from a plurality of candidate service technicians according to an expertise that the service technician is labeled with and which corresponds to the item of equipment. Scheduling deployment of the one or more parts can including identifying a provider of the one or more parts and assigning the one or more parts to a vehicle (e.g., trucks) for delivering the one or more parts to the site of the item of equipment. By using the language model to generate the prescription—which identifies the one or more parts—the one or more parts that are delivered to the site can be more accurately identified, which can reduce resource usage and/or wasted space or weight on the vehicle. In some implementations, scheduling deployment includes generating a service ticket indicative of the service to be performed, such as to identify the service technician, the parts, and/or the item of equipment.

Depending on the determined prescription, the scheduling can include automated servicing of the item of equipment, such as to provide commands to adjust parameters of the item of equipment to a controller of the item of equipment. The scheduling can include providing instructions for performing remote service, such as to provide instructions to a service technician to use on-site tools and/or parts, or manual adjustment of the item of equipment, to service the item of equipment (e.g., to avoid a truck deployment or truck roll to the site).

At 835, an application session for a service operation corresponding to the service request (and the prescription) can be provided. In some implementations, the application session is provided via a device of the service technician. For example, the device can provide one or more credentials to access the application session (e.g., credentials that uniquely identify the service technician). The application session can present information to the service technician in any of various conversational, messaging, graphical, real-time, and/or asynchronous formats. The application session can receive one or more prompts from the device (e.g., from a user input device of the device), and provide the one or more prompts to the language model to cause the language model to provide corresponding completions responsive to the one or more prompts. For example, the device can receive text or image data (among other formats) as inputs provided by actions of the user (e.g., via an input interface of the device; by the user controlling a camera of the device), and provide the inputs as prompts to the language model. The application session can present the completions via the device to facilitate guiding the service technician through the actions to perform to service the item of equipment. In some implementations, the application session automatically (e.g., responsive to detecting a condition for escalating the guidance to a human expert) or manually (e.g., responsive to user input requesting guidance from a human expert) can establish a communication session between the device and a device of a human expert to provide further guidance to the service technician; the language model can provide various information such as the service request, prescription, and/or communications between the user and the language model via the application session to the device of the human expert, and can label various portions of the communications as potential causes of the escalation. The application session can be implemented as a virtual assistant, such as to provide information such as instruction manuals or technical reports regarding the item of equipment, responsive to requests from the service technician inputted at the device of the service technician.

At 840, operation of the item of equipment can be updated responsive to one or more actions performed by the service technician. For example, various parameters of operation of the item of equipment, such as setpoints, can be updated according to the one or more actions.

In some implementations, information from the service request, prescription, and application session processes can be used to perform analytics regarding entities that maintain sites and items of equipment (e.g., to evaluate customer churn). For example, information including unstructured data (e.g., service reports) regarding items of equipment and entity engagement or disengagement (e.g., deals) can be correlated to identify patterns regarding ways that service can be performed to maintain or increase the likelihood of increasing performance of one or more items of equipment of the entity, completion of deals or of maintaining engagement with the entity.

### BMS Performance Assessment Tool

A building management system (BMS) (for example as described in U.S. Publication No. 2022/0057099 and/or U.S. patent application Ser. No. 18/115,478 filed Feb. 28, 2023, which are incorporated by reference herein in their entireties) can include multiple individual components within the BMS. Example components may include control devices, such as field equipment controllers (FECs), advanced application field equipment controllers (FAC), network control engines (NCEs), input/output modules (IOMs), and variable air volume (VAV) modular assemblies, supervisory controllers, local controllers, edge devices, control device types, etc. Further, the BMS may include equipment such as actuators, valves, AHUs, RTUs, thermostats, or any other device associated with the BMS, which are controlled by the control devices described above. Components of a BMS can also include sensors, meters, other data sources, etc.

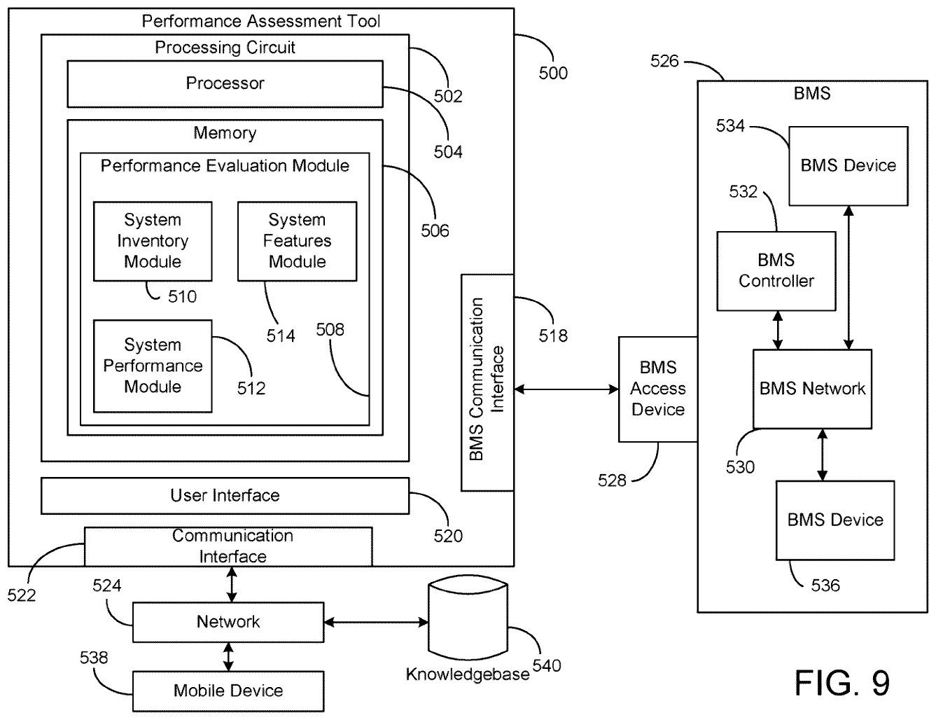

Referring now to FIG. 9, a block diagram showing a performance assessment tool 500 is provided, according to some embodiments. The performance assessment tool 500 is shown to include a processing circuit 502. The processing circuit 502 includes a processor 504 and a memory 506. The processor 504 may be a general purpose or specific purpose processor, an application specific integrated circuit (ASIC), one or more field programmable gate arrays (FPGAs), a group of processing components, or other suitable processing components. The processor 504 may be configured to execute computer code or instructions stored in the memory 506 or received from other computer readable media (e.g., CDROM, network storage, a remote server, etc.).

The memory 506 may include one or more devices (e.g., memory units, memory devices, storage devices, etc.) for storing data and/or computer code for completing and/or facilitating the various processes described in the present disclosure. The memory 506 may include random access memory (RAM), read-only memory (ROM), hard drive storage, temporary storage, non-volatile memory, flash memory, optical memory, or any other suitable memory for storing software objects and/or computer instructions. The memory 506 may include database components, object code components, script components, or any other type of information structure for supporting the various activities and information structures described in the present disclosure. The memory 506 may be communicably connected to the processor 504 via processing circuit 502 and may include computer code for executing (e.g., by processor 504) one or more processes described herein.

The memory 506 may include a performance evaluation module 508. The performance evaluation module 508 may include a number of additional modules, such as a system inventory module 510, a system performance module 512, and a system feature module 514. The performance assessment tool 500 may further include a BMS communication interface 518, a user interface 520, and a communication interface 522 for communicating with a network 524.

In some embodiments, the performance assessment tool 500 receives data from a BMS 526 via the BMS communication interface 518. In one example, the BMS communication interface 518 may access the BMS via a BMS access device 528. The BMS interface device 528 may be any type of BMS interface device. In some embodiments, the BMS interface device 528 is a mobile access point (MAP) device, such as a MAP Gateway device by Johnson Controls. In other embodiments, the BMS interface device 528 may be a Metasys server from Johnson Controls. The BMS access device 528 may be configured to collect data from the BMS 526, and may provide this data to the performance assessment tool 500 upon request. In some embodiments, the BMS access device 528 may be configured to receive a request for data from the performance assessment tool 500 and access the BMS 526 to collect the requested data. The requested data may be point data, object data, etc. However, other devices with access to a BMS network 530 within the BMS 526 are also contemplated, such as smart thermostats, dedicated BMS controllers, home hubs, or other connected devices. The BMS communication interface 518 may provide a communication link to the BMS 526. In some embodiments, the communication interface 518 is a serial interface, such as RS-232 or RS-485. In some examples, the BMS communication interface 518 may be a wireless interface such as a cellular (3G, 4G, CDMA, LTE, etc.) interface, a Wi-Fi interface, a Zigbee interface, a Bluetooth interface, a LoRa interface, etc. In other example, the BMS communication interface 518 may be other wired interfaces such as USB, Firewire, Lightning Connections, CAT5 (wired Ethernet), etc.

The BMS 526 may include a BMS network 530, one or more BMS controllers 532, and a number of BMS devices, such as BMS devices 534, 536. The BMS controller 532, and the BMS devices 534, 536 may be any of the controller or devices as described above in regards to FIGS. 1-4, above. In one example, the BMS network 530 may provide communication between the BMS controller 532, the BMS devices 534, 536 and the BMS access device 528. In some embodiments, the BMS network 530 is a BACnet network. In other embodiments, the BMS network 530 is an EthernetIP network. Alternatively, the BMS network 530 may be any other type of BMS network, as applicable.

In some embodiments, the performance assessment tool 500 is a web-based tool. For example, the performance assessment tool 500 may be hosted on a server, and accessed via a connection to the network 524 via the communication interface 522. In some examples, network 524 may be a local network such as a local area network (LAN), or a wide area network (WAN). In other examples, the network 524 may be an internet based network, which may allow a user to access the performance assessment tool 500 using a web browser, such as an HTML web browser. In other embodiments, the performance assessment tool 500 may be hosted on a server and accessed using a thin-client. In some embodiments, a user may be able to access the performance assessment tool 500 using a mobile device 538 having a connection to the network 524. For example, mobile devices such as smartphones (iphone, Android phone, Windows phone, etc.), tablet computers (iPad, Android tablet, Windows Surface, etc.), mobile computers (laptops, netbooks), stationary computers (PCs), or dedicated devices having a network interface which may be used to access the network 524. Dedicated devices may include smart thermostats, dedicated BMS controllers, home hubs, or access point devices such as a mobile access point (MAP) device from Johnson Controls. In other embodiments, the performance assessment tool 500 may be loaded onto a thick-client device, such as a laptop, personal computer (PC), or other computing device which can communicate with the BMS 526. In some examples, where the performance assessment tool 500 is loaded onto a thick-client device, a user may access the tool via the user interface 520. For example, the user interface 520 may be a user interface of the thick-client device.

In some embodiments, the system inventory module 510 may be configured to access the BMS 526 via the BMS communication interface 518 and generate an inventory list of all devices associated with the BMS 526. This inventory may include all resources of the BMS, for example devices, controllers, communication devices, access points, equipment, sensors, or any other portion of the BMS 526, including information relating to the available memory and processing capabilities of the various devices, update versions of various devices, etc., The inventory can be characterized as an indication of the available resources of the BMS. The generation of inventory lists using the system inventory module 510 can performed as described in U.S. Provisional Patent Application No. 63/356,572, filed Jun. 29, 2022 and/or U.S. Pat. No. 10,341,312 issued Jul. 2, 2019, both of which are incorporated by reference herein in their entireties. In some embodiments, the system performance module 512 is configured to access the BMS 526 via the BMS communication interface 518 and to retrieve information related to the performance of the BMS 526. The system performance module 512 may further analyze the data retrieved from the BMS 526 to generate one or more BMS performance reports. In a further embodiment, the system features module 514 is configured to access the BMS 526 via the BMS communication interface 518 and to retrieve information related to features associated with the BMS 526.

In some embodiments, the performance assessment tool 500 may be in communication with a knowledgebase 540. The knowledgebase 540 may be accessed by the performance assessment tool 500 via the network 524. The knowledgebase 540 may include information required by the performance assessment tool 500 to accurately perform the performance verification processes, as described below. In some embodiments, the knowledgebase 540 may include existing specifications for a number of BMS systems. The knowledgebase 540 may further include facility data from locations where the BMS systems are installed. Facility data may include physical plant schematics, riser diagrams, installed components, maintenance records, service contracts, etc. The knowledgebase 540 may further include historical data such as prior performance assessments, inventory assessments or feature assessments, as described in detail below. In some embodiments, the knowledgebase 540 may be a central repository for all data collected via one or more performance assessment tools.

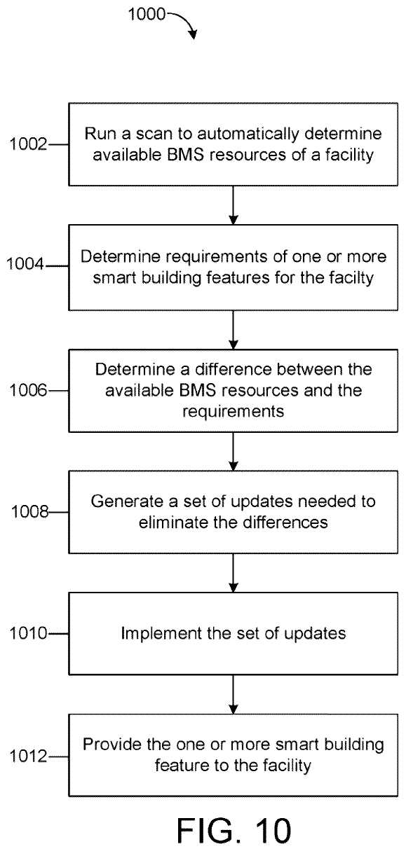

In some embodiments, the performance assessment tool 500 includes artificial intelligence and/or machine learning systems and models, for example at least some components of system 100 or system 200 according to the teachings of FIGS. 1-7. Accordingly, the performance assessment tool 500 can be configured (programmed, architected, etc.) to perform operations such as those described below with reference to FIGS. 10-14 using at least one generative AI model and/or other machine learning models.

### BMS Resource Assessment and Adaptation

As described herein with reference to FIGS. 9-14, BMSs can include or be coupled with the performance assessment tool 500 to scan available resources. It can be useful to compare the available resources with target resources (e.g., requirements) for implementing various features for BMSs and/or items of equipment, such as features associated with performance targets for operation of the BMSs and/or items of equipment (e.g., for existing equipment and/or updated or new equipment). However, the available resources and target resources/requirements may not be in similar or identical data formats or structures, which can make it difficult for computer systems to perform the comparisons using rules-based comparisons or direct text string comparisons. In addition, in some implementations, requirements for implementing features and/or satisfying performance targets may not be explicitly available or readily determined (e.g., either automatically using computer systems or based on a user's evaluation of the features or performance targets), for example given wide variation between buildings and building management systems.

For example, requirements to implement a feature such as a smart building feature (e.g., fault detection, fault prediction, predictive maintenance scheduling, air quality management, indoor navigation, active setpoint management, control optimization, demand response, digital twin functionality, carbon emissions management, net zero planning, utilization analysis, autoconfiguration, or other smart building feature) can depend on building design (e.g., number of rooms, size of building, occupancy, purpose of building such as whether the building is a hospital or an office building) and existing BMS components (e.g., varying for different types of equipment, different numbers of equipment units, different controller architectures, etc.), which can be highly variably. Systems and methods in accordance with the present disclosure can use machine learning models, including but not limited to generative AI models, to translate, compare, and/or evaluate available resources and requirements/target resources in a common data format, such as a semantic or conceptual level format, allowing for more accurate and useful determination of gaps between existing resources available at a building and resources that would allow for a new or improved feature (e.g., smart building feature) to be enabled in a BMS. Additionally (or alternatively), systems and methods in accordance with the present disclosure can use machine learning models, including but not limited to generative AI models, to generate proposed updates for eliminating a gap, difference, etc. between resources available at a BMS and a target for resource availability (e.g., required resources for a desired smart building feature), for example to generate quotes, proposals, bills of materials, work orders, pitch materials, etc. relating to projects for updating the BMS. Some embodiments herein leverage generative AI models to automatically handle the high variability across BMSs and across the complex technical requirements of various advanced features for different BMSs.

Referring now to FIG. 10, a flowchart of a process 1000 for implementing updates to a BMS to enable one or more smart building features, according to some embodiments is shown, according to some embodiments. The process 1000 can be executed by any of the various circuitry, computing systems, controllers, tools, etc. described herein and/or in combination with (or separate from) any of the processes described herein.

At step 1002, a scan is run to automatically determine available BMS resources of a facility. The scan may be run by the performance assessment tool 500, for example as described in detail above and/or in as described in U.S. Provisional Patent Application No. 63/356,572, filed Jun. 29, 2022 and/or U.S. Pat. No. 10,341,312 issued Jul. 2, 2019, both of which are incorporated by reference herein in their entireties. The scan can automatically determine which devices (e.g., controllers, gateways, computing devices, sensors, etc.) and equipment (e.g., chillers, air handling unit, variable air volume boxes, fans, dampers, valves, etc.) are present in a BMS and also provide data relating to the available (e.g., currently unused or underutilized) capacity of such devices and equipment (e.g., memory, bandwidth, processing power, CPU usage, heating/cooling capacity, luminosity, etc.) and other information (software version, firmware version, model number, device age, etc.) indicative of the resources available in a BMS.

At step 1004, requirements of one or more features (e.g., smart building features) are determined. The one or more features can include one or more of fault detection, fault prediction, predictive maintenance scheduling, air quality management, indoor navigation, active setpoint management, control optimization, demand response, digital twin functionality, carbon emissions management, net zero planning, utilization analysis, autoconfiguration, or other smart building feature in various embodiments. The requirements can represent resources to be used to support the one or more features, such as expected or target values of resources. For example, the requirements may include certain network bandwidths, edge computing capacity (e.g., on gateways, controllers, etc.), number of devices, presence of particular sensors, presence of particular types of building equipment, etc. In some embodiments and/or for some features, the requirements may be preset (static, applicable to all facilities) such that step 1004 includes reading such requirements from computer-readable memory. In some embodiments and/or for some features, the requirements can be determined in step 1004 based on results of the scan, for example where differences in equipment, sensors, devices, building characteristics, etc. affect what resources (or other requirements) are needed to provide smart building features. For example, a facility with a larger number of units of HVAC equipment may require more controllers, processing power, network bandwidth, gateways, etc. to provide a given smart building feature as compared to a facility with a lower number of units. As another example, a smart building feature may have different requirements based on a type of equipment present (e.g., forced air versus radiant heating/cooling, etc.). Tables of comparisons and/or machine-learnt relationships from historical data and/or supervised learning from synthetic data can be used to automatically determine the requirements of one or more smart building features in step 1004 as a function of one or more results of the scan in step 1002.

In some embodiments, step 1004 includes determining the requirements of the one or more features for the particular building management system using at least one generative AI model. The at least one generative AI model can be trained on data for other building management systems, for example results of scans by a performance assessment tool of such other building management systems and performance data for such building management systems (e.g., including information on the features enabled for the various building management systems). The one or more features can be enabled for at least a subset of the building management systems for which training data is collected (e.g., with enabled referring to the one or more features being actively executed within a BMS for at least some times, available for use in a BMS, having access to sufficient resources in a BMS, etc.). Such data can be used for training a generative AI model (e.g., according to the teachings above) to be able to generate the requirements of a feature (e.g., additional smart building feature) for a particular building management system of interest, for example using an indication of the currently available resources for that building management system as an input. For example, one or more training data elements can include (i) at least one of a feature or a requirement (e.g., expected or target resource usage associated with the feature) corresponding to the feature and (ii) a performance value (e.g., key performance index (KPI) value) corresponding to the at least one of the feature or the requirement, such that the at least one generative AI model can be configured using the training data elements to detect features and/or requirements according to inputted resources and/or requests for KPIs to be met for the building management system or one or more components thereof. The training data elements can include, for example, classifications of whether requirements are satisfied as described further below.

In some embodiments, the requirements include site server requirements (e.g., platform type, CPU utilization, available memory, total hard drive space, available hard drive space, operating system version, SQL version, BMS software version), engine requirements (minimum firmware version, total object count per engine, field controller(s) per trunk, engine CPU utilization, engine memory, engine flash, supervisory CPU temperature, supervisory board temperature, trend data loss, unbound references, duplicate BACnet references, out-of-service points, undetermined points, Bus Health Index, Bus Performance Index, total trend samples per hour, COV receive rates, network tolerance, network execution time, BACnet IDs, trunk errors/retries, UL support) field controller requirements (e.g., minimum hardware version, memory capacity, minimum firmware revision, quantity per trunk), object requirements (e.g., % BACnet available, % requiring trends, % with existing trends, comparisons with object availability in engine), electric meter requirements (e.g., connection to BMS), etc. in various embodiments.

At step 1006, a difference is determined between the available BMS resources (from step 1002) and the requirements of the one or more smart building features (from step 1004). Determining the difference can include comparing the available BMS resources to the requirements of the one or more smart building features, such as by identifying differences in numerical or text/semantic values between the available BMS resources for a given feature and for a corresponding requirements (e.g., target or expected resources) for the given feature. The differences can indicate a gap in computing or network capacity, a difference in equipment or devices (sensors, controllers, gateways, HVAC equipment, etc.), or other difference, including but not limited to where the available resources are less than a value of a given requirement or are not present for a given requirement, such as where a sensor to support a given requirement and/or feature is not present and/or not detected by the scan. One or more natural language processors and/or machine learning models (e.g., the at least one generative AI model) can determine the difference by detecting one or more semantic data elements (e.g., concepts represented by text and/or numerical values) from the available BMS resources and the requirements, respectively, and comparing the semantic data elements (which may be useful where the available BMS resources and requirements are stored in different formats or data structures).

In some embodiments, at least one generative AI model is used to determine the difference between the available resources of the building management system and the requirement(s) of the feature for the building management system (e.g., a smart building feature to be added to the BMS). In some embodiments, the at least one generative AI model is executed to determine the requirements for the particular building management system which can then be directly compared to the indication of available resources of the BMS in step 1006. In some embodiments, the at least one generative AI model outputs the differences, omitting a step of generating the requirements for the particular building management system and comparing to an indication of available resources of the BMS in step 1006. Use of the at least one generative AI model trained on data associated with other building management systems provides for determination of the difference(s) via a cross-site comparison between the available resources of the building management system and a plurality of additional building management systems, where the feature is present in at least one of the plurality of additional building management systems. In some embodiments, the at least one generative AI model is configured to generate, in step 1006, a description, characterization, visualization, etc. of the difference between the available resources and requires of a feature for addition to the BMS.

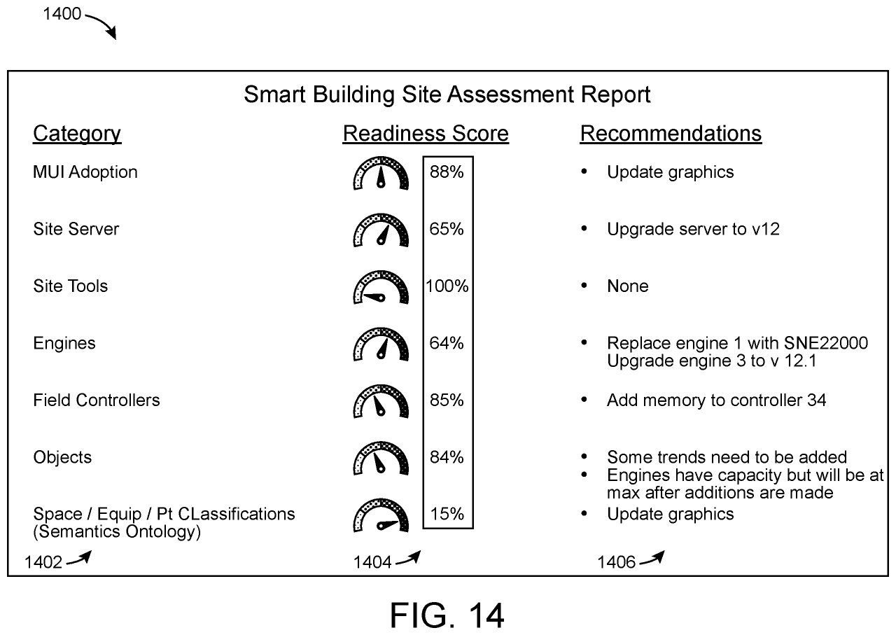

In some embodiments, step 1006 includes classifying each requirement as fully satisfied (e.g., a green category), entirely unsatisfied (e.g., a red category, show stopper category), and partially satisfied (e.g., a yellow category, warning category). The delineation between such categories can be defined by the requirements as determined in step 1004. A report, dashboard, graphical user interface, etc. showing the differences can be automatically generated and output to a user in step 1006, for example a report which color-codes the BMS requirements as green, yellow, or red depending on whether that requirement is satisfied, partially satisfied, or unsatisfied. For example, a requirement relating to trends may be “green” if all trends are already existing and engines have adequate capacity, “yellow” if some trends need to be added and engines will be at/near capacity after additions are made, and “red” if no trends are available and the engine does not have capacity to add the trends. As another example, a requirement may be “green” if it will not exceed object limits, “yellow” if it will reach the object limits, and “red” if it will exceed object limits. Such classification or color-coding can be provided at the level of individual requirements, the level of categories of requirements or devices (e.g., site server, engines, objects), at the building level (e.g., for campuses or portfolios of multiple buildings), etc. An example of such a dashboard is shown in FIG. 14 and described with reference thereto.

At step 1008, a set of updates expected or needed to reduce or eliminate the difference between the available BMS resources and the requirements of the one or more smart building features is determined. The set of updates can include installing new devices, installing new equipment, reconfiguring existing devices or equipment, providing software updates, upgrading existing devices or equipment, etc. In some embodiments, determining the set of updates includes running an algorithm optimization process which determines the set of updates that will eliminate the difference given one or more criteria, such cost, time, or compatibility criteria for executing the update(s). For example, the updates can be selected to include one or more updates expected to be performed at lowest cost, for example the lowest combined cost of purchasing new devices or equipment and of labor in performing any installations, configurations, etc. needed to implement the set of updates (e.g., using an objective function that includes a first term accounting for the cost of purchasing new devices and a second term account for a cost of installing and configuring new devices). In some embodiments, determining the set of updates can including determining a quote (estimate, cost, etc.) associated with implementing the set of updates, and displaying the quote to a user, for example so that a user can determine whether enabling the one or more smart building features is worth the associated cost of the updates.

In some embodiments, step 1008 includes performing, by at least one generative AI model, one or more actions according to the difference determined in step 1006. For example, step 1008 can include generating, using the at least one generative AI model, a customized script for presenting the proposed update to a building manager, for example a script explaining in natural language (e.g., readable prose, video, audio) updates that would be needed to eliminate the difference such that a feature can be enabled, the scope (e.g., time, cost, resources, etc.), and/or a forecasted benefit of performing such a change. In some embodiments, step 1008 includes generating, using the at least one generative AI model, a quote for implementing the proposed update and/or a scope of work, purchase order, bill of materials, invoices, or other project documentation for implementing the proposed update. Accordingly, documents used for requisition and organization of a project to implement the updates can be automatically generated in step 1008 based on data-driven artificial intelligence, eliminating time-consuming and unreliable manual creation. In such embodiments, the at least one generative AI model can be trained on (e.g., fine-tuned using) project documentation (e.g., scope of work, purchase orders, bills of materials, invoices, etc.) associated with prior projects of other building management systems, where generative artificial intelligence can be used to parse such documentation (which may be provided in an unstructured format) into a form suitable for model training and in the generative model itself for creating project documentation according to templates suitable for different users, customers, service providers, etc. according to various teachings herein. The generative artificial intelligence model can be trained on such project documentation and/or restructured project documentation to enable the model to automatically generate project documentation consistent with the proposed update for a particular building management system.

In some embodiments, step 1008 can include generating, using the at least one generative AI model, settings, parameters, commissioning data, etc. for new equipment, controllers, sensors, etc. to be installed as part of the one or more updates, such that step 1008 provides technical data useful in implementing the updates. In some embodiments, step 1008 includes generating building servicing work orders, service workflow information, installation instructions, etc. according to teachings above relating to building servicing which are adapted to facilitate installation, configuration, service, etc. of components of a BMS to provide the determined updates, for example a video showing instructions for implementing the updates.

In some embodiments, the one or more actions include causing a user to collect additional information relating to the BMS, for example by transmitting, by the one or more processors to a device of a user associated with the one or more items of equipment, an instruction to retrieve information regarding the available resources. Retrieving the information can include manually checking (by a user) equipment or device status, collecting state data, capturing a photograph or video, or providing natural language input regarding observations by the user. The client device 304 and/or other hardware contemplated herein can be adapted to receive such information from the user, for example using a conversational interface. Process 1000 can thereby include iterative steps in which a user is prompted to provide additional information that can be used as inputs to the at least one generative AI models, enabling the at least one generative AI models to improve its outputs, improve confidence in or reliability of its outputs, etc. For example, steps 1004, 1006, 1008 can be re-executed after such information is collected by a user and provided to the system. Such iterative steps, user interactions, user feedback, etc. can be used as feedback to further update and improve the at least one AI model used in process 1000.

At step 1010, the set of updates is implemented. Implementing the set of updates can include installing and configuring new devices and/or equipment (e.g., controllers, gateways, sensors, HVAC equipment, lighting equipment, security equipment, etc.). Implementing the set of updates can include automated actions such as automatically providing over-the-air software updates to devices or equipment of a building management system, automatically changing control logic for equipment to affect operation of such equipment in affecting a variable state or condition (temperature, humidity, pressure, etc.) of the building, etc. In some embodiments, step 1010 includes automatically configuring and/or commissioning the new devices or equipment according to parameters determined by the at least one generative AI models. In some embodiments, step 1010 includes providing a virtual assistance implemented using generative AI techniques according to teachings herein that guides a technician through the installation, commissioning, etc. steps needed to implement the set of updates. Various requisition, work order, scheduling, project management, and other project-related tasks and documentation can be generated by the at least one generative AI models to enable, cause, and otherwise facilitate implementation of the updates in step 1010.

At step 1012, one or more smart building features are provided to the facility. In some embodiments, the one or more smart building features are activated automatically in response to implementation of the set of updates in step 1010. The one or more smart building features can included one or more of fault detection, fault prediction, predictive maintenance scheduling, air quality management, indoor navigation, active setpoint management, control optimization, demand response, digital twin functionality, carbon emissions management, net zero planning, utilization analysis, autoconfiguration, or other smart building feature in various embodiments. In some embodiments, at least one of the one or more smart building features operates in step 1012 such that control of equipment of the building is modified in an automated (e.g., closed-loop) manner by a smart building feature enabled by implementation of the set of updates, thereby influencing operation of the equipment to affect one or more variable states or conditions of the building. Performance of a building management system and equipment therein can thereby be improved by the teachings herein (e.g., higher equipment efficiency, lower energy use, lower carbon emissions, active fault avoidance or mitigation, etc.).

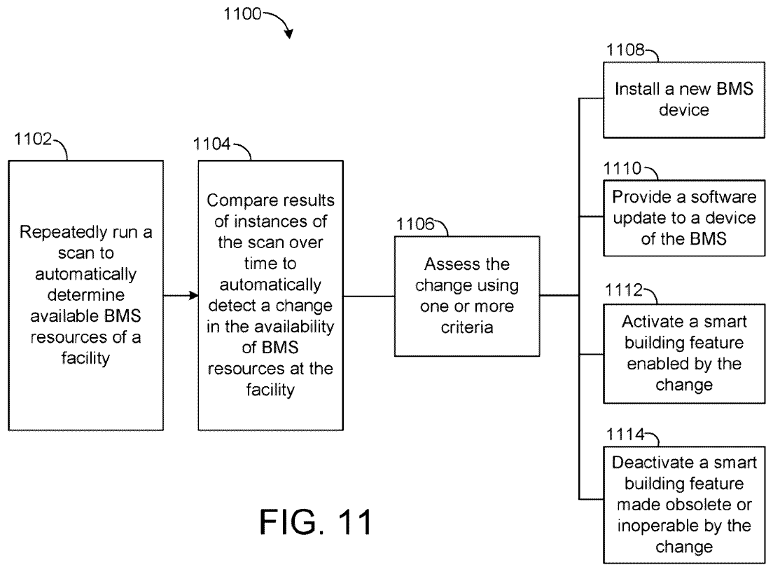

Referring now to FIG. 11, a flowchart of a process 1100 for automatically implementing changes to BMS features in response to changes in available resources of a BMS, according to some embodiments. The process 1100 includes can be executed by any of the various circuitry, computing systems, controllers, tools, etc. described herein and/or in combination with (or separate from) any of the processes described herein.

At step 1102, a scan is repeatedly run which automatically determines available BMS resources of a facility. Each scan can be similar to the scan of step 1002 of FIG. 10 described above, for example a scan by the performance assessment tool 500 described herein. The scan can be run periodically (e.g., every minute, every hour, every day, every week, every month, etc.), on demand from a user, or in response to satisfaction of a criterion, occurrence of an event, etc., Step 1102 provides results of multiple scans (e.g., two, three, four, etc.) indicating the available BMS resources at the time of running of the corresponding scan.

At step 1104, results of the scan over time are compared to automatically detect a change in the availability of BMS resources at the facility. Scan results can be stored for at least sufficient time to allow comparison to one or more (e.g., two, three, etc.) subsequent scans. Step 1104 can include automatically finding whether a change occurred between scans and identifying the scope of such a change. In some embodiments, step 1104 includes displaying results of the scans and any changes therebetween in a graphical user interface. Several scans can be compared from various times such that both discrete/immediate changes and longer-term (e.g., gradual) changes can be detected in step 1104.

At step 1106, in response to detection of a change in step 1104, a change is assessed using one or more criteria. Assessing the change in step 1104 may include comparing a quantification of a degree of the change to a threshold value, for equipment where the quantification of the degree of the change is a number of devices affected (added, removed, offline, etc.), a percentage of building spaces affected, and/or a score/metric/etc. generated to quantify the amount of change. In some embodiments, assessing the change in step 1104 can include comparing the change or the changed features to current standards, latest software updates, latest firmware updates, etc., In some embodiments, assessing the change in step 1104 can include assessing whether the change is a certain type of change, for example whether the change adds a new unit of equipment, a new sensor, a new devices of a particular type or removes (e.g., via devices or equipment fault or failure) a unit of equipment, sensor, device, etc. In some embodiments, assessing the change in step 1104 can include comparing the change to requirements of a smart building feature. The smart building function may already be enabled for the BMS or may be a smart building feature not previously utilized for the BMS. In some embodiments, the change can be assess in step 1106 using at least one generative AI model according to the teachings herein. For example, the at least one generative AI model may be trained on a set of data relating changes in BMSs and prior expert descriptions of such changes or prior data regarding consequences of such changes, such that the at least one generative AI model can provide contextual data, recommendations, descriptions, projections, etc. based on a detected change.

A result of the assessment in step 1106 can be used to select a step to implement in response to the detected change, for example a step selected from any of steps 1108, 1110, 1112, and/or 1114.

At step 1108, a new BMS device is installed. Step 1108 can include, for example, automatically causing the new BMS device to be shipped to a facility and generating an automated work order for installation of the new BMS device. Step 1108 can be provided, for example, where the assessment in step 1106 results in a finding that the change in step 1104 is associated with failure (breakdown, shutdown, etc.) of a device or other insufficiency of an existing device. For example, the new BMS device installed in step 1108 may replace a previous device rendered obsolete or incompatible by the change in the BMS (e.g., by upgrading or replacement of other components). Automatically detecting the need for such installations and causing implementation of such installations provides a user-friendly, reliable, robust process for ensuring that a BMS maintains (or improves) functionality as changes are made to the BMS that might otherwise result in difficult-to-diagnose errors and alarms. In some embodiments, at least one generative AI model is used to determine a new BMS device for installation, generate an order for the new BMS device to be delivered and installed, generate a quote for purchase an installation of the new BMS device, etc., in various embodiments.

At step 1110, a software update is provided to a device of the BMS, for example automatically and over a network (over the air, remote update, etc.). In some embodiments, step 1110 can be executed when the assessment of the change finds that certain devices would lose interoperability without software updates, for example to a newer version compatible with newly-installed devices. In some embodiments, step 1110 can be executed when the assessment of the change finds that a new software feature can be provided on a device due to the change (e.g., in response to new availability of new sensors or equipment). In some embodiments, at least one generative AI model is used to determine and/or generate the newer version of software to be implemented via a software update in step 1110.

At step 1112, a smart building feature enabled by the change is activated. Step 1112 can be executed in response to an assessment in step 1106 that determines that the change enables the smart building feature, for example by comparing requirements of the smart building feature (e.g., sensors, devices, memory, computing power, bandwidth, equipment needed for successful operation of the smart building feature) to the results of the scan after the change and/or comparing the change to previously-identified differences between the BMS resources and the requirements of the smart building feature. The smart building feature can included one or more of fault detection, fault prediction, predictive maintenance scheduling, air quality management, indoor navigation, active setpoint management, control optimization, demand response, digital twin functionality, carbon emissions management, net zero planning, utilization analysis, autoconfiguration, or other smart building feature in various embodiments.

At step 1114, a smart building feature is deactivated. Step 1114 can be executed in response to an assessment in step 1106 that the smart building feature is obsolete or inoperable following the change detected in step 1104. For example, the change may enable a more advanced version of the smart building feature to be applied (e.g., due to installation of different or upgraded devices or equipment), such that the advanced version is activated in step 1112 and the older, obsolete version is deactivated in step 1114. As another example, the change may indicate a change in utilization of a space (e.g., changing a space from a cafeteria to a classroom, from a waiting room to an operating room, etc.) that renders a smart building feature for that space no longer useful given the change in purpose of the space, such that the smart building feature can be deactivated. As another example, the change may indicate that the resources needed for a smart building feature are no longer available, for example due to breakdown, failure, disconnection, shutdown, removal, etc. of a device or equipment from a BMS, in response to which a smart building feature relying thereon is deactivated at step 1114. Deactivating smart building features automatically in step 1114 can advantageously reduce errors, alarms, erroneous metrics, erroneous control, energy waste, etc. that may otherwise occur from attempting to execute obsolete or inoperable smart building features.

The process 1100 of FIG. 11 thereby provides for automated changes to a building management system in response to changes therein detected by repeatedly scanning the BMS, for example using the performance assessment tool described in detail above.

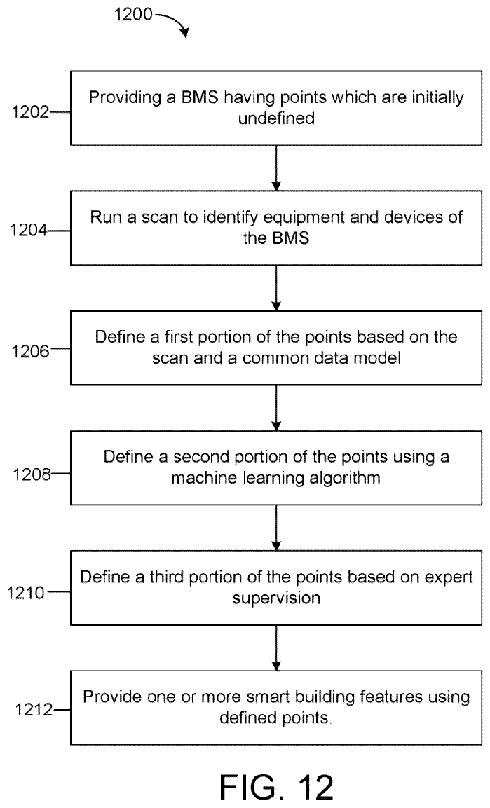

Referring now to FIG. 12, a flowchart of a process 1200 for defining points of a building management system and providing one or more smart building features using the defined points is shown, according to some embodiments. The process 1200 includes can be executed by any of the various circuitry, computing systems, controllers, tools, etc. described herein and/or in combination with (or separate from) any of the processes described herein.

At step 1202, a BMS is provided having points which are initially undefined. The points can correspond to various types of sensor data, operating values, settings, etc. in the BMS. The BMS may be a newly-installed BMS or may be a legacy BMS operating at a building. It can be difficult to determine the meaning of points provided by a BMS, as the points can represent a wide variety of conditions, settings, operations, etc. At step 3720, multiple points start process 1200 as undefined, i.e., such that the meaning thereof is unknown, which can prevent successful execution of certain smart building features.

At step 1204, a scan is run to identify equipment and devices of the BMS. The scan can be a scan by the performance assessment tool 500 described above or similar scan. The scan can output a list of equipment and devices included in the BMS, for example.

At step 1206, a first portion of the points are defined based on the scan and a common data model. The common data model may provide space information (space ontology) indicating the spaces of a building associated with different devices, equipment, etc. found by the scan. The common data model may be as described in U.S. Pat. No. 11,221,614, filed Apr. 10, 2018, the entire disclosure of which is incorporated by reference herein. The common data model may be used by the BMS, for example. In some embodiments, equipment and devices are programmed to self-identify themselves to a BMS using the common data model. Step 1206 includes using (e.g., combining) information in the common data model and the identified devices and equipment from the scan to define a first portion of the points of the BMS. The first set of points can include or relate to points matching standard naming conventions, points matching standard instance numbers, and equipment matching standard naming conventions.

At step 1208, a second portion of the points are defined using one or more machine learning algorithms. Inputs to the one or more machine learning algorithms can include data for the points (e.g., timeseries data for each point), the definitions for the first portion of the points, information from the common data model, etc. The one or more machine learning algorithms can be trained on sets of training data from BMSs with known/defined points, for example to classify sets of timeseries data for different points into different point definitions. Neural networks arranged as classifiers (e.g., trained via supervised learning) can be used as the machine learning algorithms in step 1208. The various teachings herein relating to generative AI models can also be adapted to enable step 1208. Step 1208 can detecting relationships between points (e.g., points with data values that move together, a point dependent on another point, etc.) and use such relationships to help infer the identify of such points (e.g., based on physical relationships between the conditions, parameters, settings, etc. represented or affected by such points).

In some embodiments, the one or more machine learning algorithms are configured to output a definition for each undefined point and a probability that the point has that definition, with step 1208 setting the definition of the second portion of points where the probability is greater than a threshold value for the second portion of the points. Points for which the probability is less than the threshold value may stay undefined following steps 1208.

At step 1210, a third portion of the points are defined based on expert supervision. Step 1210 can include generating a graphical user interface of the points, associated data, results of the scan, definitions of the first and second portions of points, etc. The graphical user interface can include options for a user to input definitions of the third portion of points, for example via free-text entry, using drop-down menus, etc. Step 1210 can include providing recommendations or suggestions (e.g., based on outputs of the machine learning algorithms such as at least one generative AI model in step 1208) with respect to the definitions for the third portion of points for confirmation or denial by the expert. In some embodiments, step 1210 includes filtering a set of options available to be selected for the third portion of points based on results of preceding steps of process 1200, thereby facilitating user selection of appropriate point definitions. Due to automated definition of the first portion of points and the second portion of points, the burden on the user to select point definitions in sept 1210 is thus greatly reduced as compared to other implementations where all points are defined manually.

At step 1212, one or more smart building features are provided using the defined points. Step 1212 can include executing control functions or other smart building features that affect operation of equipment in serving a space (e.g., in affecting a variable state or condition of a building) such that process 1200 culminates in updated operation of building equipment. Smart building features can include one or more of fault detection, fault prediction, predictive maintenance scheduling, air quality management, indoor navigation, active setpoint management, control optimization, demand response, digital twin functionality, carbon emissions management, net zero planning, utilization analysis, or other smart building feature in various embodiments. In some embodiments, the point definitions from process 1200 are used to populate a digital twin of a facility served by the BMS which is then used to implement the one or more smart building features.

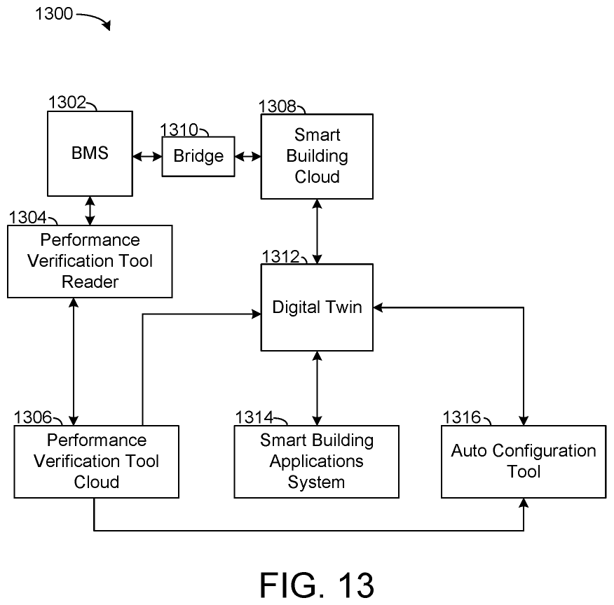

Referring now to FIG. 13, a block diagram of a system 1300 that can be used to provide features described herein is shown, according to some embodiments. The system 1300 includes a variety of computing components that can be implemented in one or more locations, distributed across multiple computing devices (e.g., at a building served by a BMS and in a cloud server, data center, etc.), etc. As shown in FIG. 38, the system 1300 includes BMS 802, a performance verification tool (PVT) reader 1304 communicable with the BMS 1302 (e.g., to run a performance assessment scan as described in detail above), a PVT cloud system 1306 communicable with the PVT reader 1304 (e.g., to receive and store scan results from the PVT reader 1304, provide user access to view results of multiple scans, provide process 1000 and/or 1100, etc.), a smart building cloud 1308 (shown as OpenBlue Cloud 1308), communicable with the BMS 1302 via a smart building bridge 1310 (shown as OpenBlue Bridge 1310), a building twin 1312 (shown as OBT 1312) communicable with both the PVT cloud 1306 and the smart building cloud 1308, a smart buildings applications system 1314 (shown as OpenBlue Enterprise Manager Apps 1314) communicable with the building twin 1312 (e.g., to provide smart building features using the building twin 1312), and an autoconfiguration tool 1316 (shown as OpenBlue Auto-Configurator 1316) communicable with the PVT cloud 1306 and the building twin 1312 to provide autoconfiguration features (e.g., process 1200) to the building twin 1312 based on scan information from the PVT cloud 1306. Generative AI features according to the teachings herein can be implemented in some or all of the blocks of the diagram of FIG. 13.

Referring now to FIG. 14, a smart building site assessment report 1400 is shown, according to some embodiments. The smart building site assessment report 1400 can be provided to a user via graphical user interface (e.g., displayed on a screen), for example in a similar manner and/or in combination with the various reports, dashboards, etc. shown in FIGS. 8-12, 14-29, and 31-33. The smart building site assessment report 1400 can be generated as part of process 1000 and/or process 1100 in some embodiments, and can be provided by PVT cloud 1306 of FIG. 38 in some embodiments. In some embodiments, the smart building site assessment report 1400 is generated using at least one generative AI model.

As shown in FIG. 14, the smart building site assessment report 1400 includes a category column 1402 listing categories of features of a building management system and/or of requirements of one or more smart building features. As shown in FIG. 39, the categories can include adoption of a current building management system (e.g., Metasys® User Interface by Johnson Controls), site server, site tools, engines, field controllers, objects, and classifications (e.g., space, equipment and point classifications). In some embodiments, the categories may change across different instances of the smart building site assessment report depending on characteristics of a site and/or requirements of different smart building features. In some embodiments, the category column 1402 includes an option to expand, drill down, etc. into a category from the list to see sub-categories, types of requirements for a category, etc. displayed in a similar manner as the categories in FIG. 39.

The smart building site assessment report 1400 is also shown as including a readiness score column 1404. The readiness score column 1404 shows a readiness score for each category and a visualization of the readiness score. In the example shown, the readiness score is provided as a percentage of full readiness (normalized between 0% and 100%). The readiness score can be calculated for each category as part of determining differences between the existing capabilities of a site and the requirements of the one or more smart building features in step 1006 of process 1000, in some embodiments. The readiness score can be calculated by comparing a number of requirements already met by a site to a total number of requirements (e.g., as a ratio), for example. As shown in FIG. 39, the readiness score column 1404 also includes a visualization of each readiness score (shown as a colored meter), for example such that the categories can be color-coded based on readiness score (e.g., green for higher values, yellow for middle values, red for lower values). In some embodiments, the smart building site assessment report 1400 allows a user to select different smart building features (e.g., from a list with check boxes, drop down menu, etc.) and calculates the readiness scores based on the selected features.

The smart building site assessment report 1400 is also shown as including a recommendations column 1406. The recommendations column 1406 provides recommendations corresponding to the categories of the categories column 1402, for example by indicating one or more recommendations (or, e.g., “None”) for each category. Recommendations are thus displayed which correspond to the different categories. For example, a recommendation to replace or upgrade a particular engine may be listed in the recommendations column 1406 in a manner that aligns with the engines category in the category column 1402 and the readiness score for engines in the readiness column 1404. The recommendations column 1406 can thus provide guidance to a user for increasing the readiness scores shown in the readiness column 1404. In some embodiments, the readiness scores are recalculated and the smart building site assessment report 1400 is refreshed after one or more of the recommendations are executed. The smart building site assessment report 1400 can thereby provide an up-to-date overview of the readiness of a site for one or more smart building features and recommendations for improving the readiness of the site.

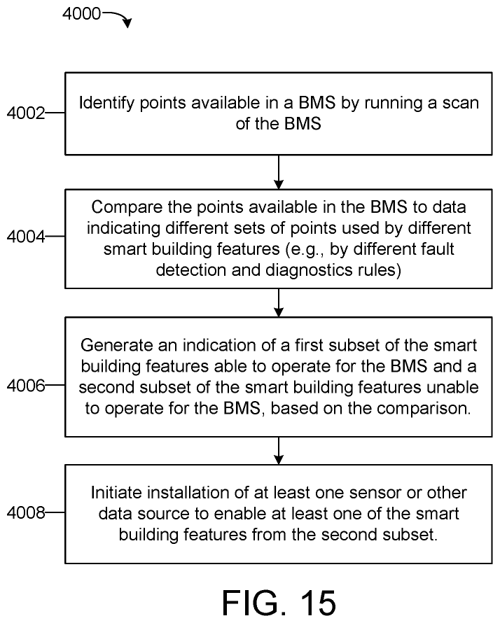

Referring now to FIG. 15, a flowchart of a process 4000 for automatically identifying fault detection and diagnostics (FDD) rules able to be executed (or unable to be executed) for a building management system is shown, according to some embodiments. The process 4000 can be executed by any of the various circuitry, computing systems, controllers, tools, etc. described herein and/or in combination with (or separate from) any of the processes described herein.

At step 4002, points available in a building management system (BMS) are identified by running a scan of the BMS. The scan may be run by the performance assessment tool 500, for example as described in detail above. The scan can automatically find points available in the BMS, i.e., data sources, sensors, meters, etc. providing data for the BMS. Step 4002 can include executing process 1200 to find undefined points and to automatically define the points (e.g., with or without expert supervision, using an artificial intelligence approach, etc.) such that points are identified and defined, labelled, tagged, provided with a building ontology, etc. such that the meaning of each point is identified in step 4002. For example, step 4002 can include finding a sensor providing data to a field control by running a scan (e.g., by the performance assessment tool 500) and then determining and/or verifying what information is being provided by that sensors (e.g., that the sensor is measuring an indoor air temperature, that the sensor is measuring an air flow rate in an air handling unit, that the sensor is measuring pressure in a chiller refrigeration cycle, that the sensor is located in a particular space or its measurements affected by a particular unit of equipment, etc.)

At step 4004, the points available in the BMS as identified in step 4002 are compared to data indicating different sets of points used by different smart building features, for example by different fault detection and diagnostics (FDD) rules or by different AI analytics or predictive control tools. Platforms for building managements systems may have dozens, hundreds, thousands, etc. of available rules that can trigger faults, alerts, alarms, maintenance recommendations, etc., but which are reliant on relevant points as inputs to enable such rules to work, with different rules relating to different information and using different points. For example, a first FDD rule relating to a chiller may be based on measurement of a first set of points relating to the chiller (e.g., chilled water supply temperature, chiller compressor frequency, vibration frequency) and a second FDD rule relating to an airside system may be based on a different, second set of points (e.g., damper position, measured air flow rate, supply air temperature). Accordingly, the ability of such rules to be executed at a particular building management system is dependent on the points available in that building management system. Advantageously, step 4004 can include automatically comparing the points available in the BMS to various different sets of points used by different rules or other smart building features. Step 4004 can include checking whether all of the points used by a given rule are included in the points available in the BMS, and repeating such a check for the various different rules. In some embodiments, the comparison process can be improved in efficiency by structuring the comparison process to include or exclude sets (categories, etc.) of rules based information from the scan of the BMS, for example information indicating what types of building equipment or systems are included in the BMS (e.g., excluding chiller-related rules if no chiller is included in the BMS). In some embodiments, at least one generative AI model can be used in step 4004 to automatically select a subset of a library of FDD rules which may be of relevance or irrelevance to a particular building (e.g., based on the points, equipment, devices, etc. detected) so as to eliminate some rules from consideration, thereby reducing the computational resources (memory, computing time, processor load, etc.) required to complete the comparisons in step 4004.

At step 4006, based on the comparison of step 4004, an indication is generated of a first subset of the smart building features able to operate for the BMS and a second subset of the smart building features unable to operate for the BMS. The first subset can include the rules (or other features) which use points which are fully included in the points available in the building management system, while the second subset can include the rules (or other features) that use at least one point which is missing from the building management system. Step 4006 can include generating lists of the first subset of smart building features and the second subset of the smart building features. In some embodiments, the indication includes an indication of a count, percentage, ration, etc. of smart building features (e.g., FDD rules) in the first subset as compared to the total available smart building features or as compared to the second subset, thereby providing an estimate of the overall ability of the BMS to implement the smart building features. The indication can be provided to a user via a graphical user interface to facilitate assessment of the building management system and the available rules, for example. In some embodiments, the indication is used to enable or disable smart building features for the building management system, for example as described with respect to process 1100. In some embodiments, the indication is used to determine whether it would be feasible or desirable to provide a smart building service for the particular building management system (e.g., avoiding use of additional computing resources, investment, etc. where few smart building features would be operational, generating a recommendation for implementation of smart building services where most of the potential smart building features would be operational, etc.). In some embodiments, at least one generative AI model is used in step 4006 to generate a natural-language summary of the available smart building features and the actions that can be taken based on the results of step 4004 and 4006.

At step 4008, installation of at least one sensor or other data source is initiated to enable at least one of the smart building features from the second subset. Step 4008 can include identifying a point that, if added to the points already available at the building, would enable a desired smart building feature. Step 4008 can include identifying a point or set of points that, if added, would enable the highest number of smart building features (e.g., at the lowest cost, at the lowest number of new device installations), for example such that step 4008 can include automatically recommending installation of a particular sensor that would enable multiple smart building features prioritized over installation of a different sensor that would enable fewer smart building features and/or lower priority smart building features. Step 4008 can include automatically generating, for example based on the scan executed in step 4002, details on where the at least one sensor or other data source should be installed (e.g., a particular space, a particular part of unit of equipment, etc.) and can include facilitating commissioning of such sensor or other data source based on the information collected and generated in process 4000. Step 4008 can implement such features using at least one generative AI model to generate a plan (e.g., work order, quote, pitch, project scope, natural-language description of tasks and benefits, etc.) for implementing various smart building features, for example including a summary of the potential benefits of such work in natural language. Step 4008 can include physically installing sensors and/or other equipment or devices in accordance with such documentation and recommendations generated by at least one generative AI model. Additional smart building features enabled by such installation can then be enabled and executed.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method, comprising:
performing, by one or more processors, a scan of a building management system to determine an indication of available resources of the building management system;
determining, by the one or more processors, by processing the indication of the available resources of the building management system using at least one generative artificial intelligence (AI) model, a difference between the available resources of the building management system and one or more requirements of a feature for the building management system; and
performing, by the one or more processors, one or more actions according to the difference.

2. The method of claim 1, wherein the one or more actions comprise providing, by the one or more processors, a signal to modify the available resources according to the difference.

3. The method of claim 1, wherein the one or more actions comprises generating, using the at least one generative AI model, a proposed update for eliminating the difference and enabling the feature for the building management system.

4. The method of claim 3, further comprising generating, using the at least one generative AI model, a customized script for presenting the proposed update to a building manager.

5. The method of claim 3, further comprising generating, using the at least one generative AI model, a quote for implementing the proposed update.

6. The method of claim 3, further comprising generating, using the at least one generative AI model, a scope of work, purchase order, or bill of materials for implementing the proposed update.

7. The method of claim 3, wherein the proposed update comprises installing a new device or equipment unit in the building management system, wherein the one or more actions further comprise generating configuration parameters or settings for the new device or equipment unit.

8. The method of claim 1, wherein the one or more actions comprise generating, by the at least one AI model using the indication, a video comprising a demonstration of a maintenance action for reducing or eliminating the difference.

9. The method of claim 1, wherein the one or more actions comprise transmitting, by the one or more processors to a device of a user associated with the one or more items of equipment, an instruction to retrieve information regarding the available resources, wherein retrieving the information comprises manually checking equipment or device status, collecting state data, capturing a photograph or video, or providing natural language input regarding observations by the user.

10. The method of claim 1, wherein the at least one generative AI model comprises at least one neural network comprising a transformer.

11. The method of claim 1, wherein determining the difference comprises cross-site comparison between the available resources of the building management system and a plurality of additional building management systems, wherein the feature is present in at least one of the plurality of additional building management systems.

12. The method of claim 1, wherein the at least one generative AI model is configured using training data comprising sets of resources and enabled features of a plurality of additional building management systems.

13. The method of claim 12, wherein the at least one generative AI model is configured using training data comprising project documentation comprising one or more of quotes, estimates, scopes of work, bills of materials, installation records, or invoices.

14. The method of claim 1, wherein the difference comprises lack of a sensor, lack of sufficient computing resource availability, or lack of a type of equipment.

15. A processing system programmed to:
perform a scan of the building management system to determine an indication of available resources of the building management system;
determine by processing the indication of the available resources of the building management system using at least one generative artificial intelligence (AI) model, a difference between the available resources of the building management system and a requirements of a feature for the building management system; and
perform one or more actions according to the difference.

16. A method for training a generative artificial intelligence (AI) network, comprising:
providing results of a plurality of scans of a plurality of building management systems configured to determine available resources of the plurality of building management systems; and
providing performance data relating to the plurality of building management systems;
adapting the generative AI network using the results and the performance data such that the generative AI network is configured to generate content describing an action to perform to update a particular building management system to achieve a performance enhancement for the particular building management system.

17. The method of claim 16, wherein the performance data comprises indications of smart building features enabled at the plurality of building management systems.

18. The method of claim 16, further comprising:
providing project documentation comprising one or more of quotes, estimates, scopes of work, bills of materials, installation records, or invoices; and
adapting the generative AI network using the project documentation such the generative AI network is configured to generate proposed project documentation regarding implementing the update.

19. A method, comprising:
performing, by one or more processors, a scan of a building management system to determine an indication of available resources of the building management system;
automatically generating, by the one or more processors, by processing the indication of the available resources of the building management system, a proposal for resolving a difference between the available resources of the building management system and a requirement of a feature for the building management system; and
performing, by the one or more processors, one or more actions according to the proposal.

20. The method of claim 19, wherein the feature for the building management system is expected to improve performance of the building management system, wherein generating the proposal is based on data from a plurality of additional scans of a plurality of additional building management systems and performance data for the plurality of additional building management systems.
